(19) United States
(12) Patent Application Publication
(10) Pub. No.: US 2017/0139554 A1
(43) Pub. Date: May 18, 2017

(54) ELECTRONIC APPARATUS AND DISPLAY CONTROL METHOD

(71) Applicant: Kabushiki Kaisha Toshiba, Tokyo (JP)

(72) Inventors: Yoichi Nakabayashi, Yokohama Kanagawa (JP); Masaaki Miyatake, Akishima Tokyo (JP); Kouichi Ogi, Hanno Saitama (JP)

(21) Appl. No.: 15/056,008

(22) Filed: Feb. 29, 2016

(30) Foreign Application Priority Data
Nov. 18, 2015 (JP) 2015-225511

(51) Int. Cl. G06F 3/0482; G06F 3/0485; G06F 17/30

(52) U.S. Cl. CPC G06F 3/0482; G06F 17/3028; G06F 3/0485; H04W 84/12

(57) ABSTRACT

According to one embodiment, an electronic apparatus includes a processor. The processor displays, when display of a list of images is requested, thumbnails corresponding to the images based on attributes associated with the images, displays a first element on a first thumbnail arranged at a first position of the thumbnails, the first element indicative of a first attribute associated with a first image corresponding to the first thumbnail, and displays, when the first element is selected, elements indicative of attributes precedent to or subsequent to the first attribute of the attributes associated with the images.

### CROSS-REFERENCE TO RELATED APPLICATIONS

This application is based upon and claims the benefit of priority from Japanese Patent Application No. 2015-225511, filed Nov. 18, 2015, the entire contents of which are incorporated herein by reference.

### FIELD

Embodiments described herein relate generally to an electronic apparatus which displays data in external storage on a screen and a display control method applied to the apparatus.

### BACKGROUND

In recent years, even in general users, opportunities to handle a large number of images (photographs) are increasing by the spread of digital cameras and mobile apparatuses (for example, smartphones and tablet computers) having a camera function.

Such images are sometimes stored in an external storage device, for the purpose of, for example, data backup or keeping a free storage area in the mobile apparatus. The mobile apparatus can display the stored images by accessing the external storage device.

Further, various image display applications capable of assisting the user in retrieving a desired image from a large number of images are proposed. As one of representative functions of these image display applications, there is a function of displaying a list of images. The user can browse the images by using the list or select an interesting image from the list.

However, the number of images, which can be displayed, for example, on the small screen of a smartphone at a time, is limited, and hence in order to find a desired image from the list of images, there is a possibility of the user having to scroll the list of images repeatedly. Accordingly, realization of a new technique of providing a list of images enabling the user to find the desired image easily is required.

### BRIEF DESCRIPTION OF THE DRAWINGS

FIG. 1 is an exemplary view showing an external appearance of an electronic apparatus according to an embodiment, and external storage connected to the electronic apparatus.

FIG. 2 is a view showing an example of a list of thumbnail images of images.

FIG. 3 is an exemplary block diagram showing a system configuration of the electronic apparatus of the embodiment.

FIG. 4 is an exemplary block diagram showing a functional configuration of an image display application program executed by the electronic apparatus of the embodiment.

FIG. 5 is a view showing a configuration example of file attribute data used by the electronic apparatus of the embodiment.

FIG. 6 is a view for explaining an example of a screen on which an element indicative of a date is displayed on a list of thumbnail images by the electronic apparatus of the embodiment.

FIG. 7 is a view for explaining an example of a screen on which a list of elements indicative of dates is displayed on the list of thumbnail images of FIG. 6.

FIG. 8 is a view for explaining an example of a screen of a case where the list of elements indicative of dates of FIG. 7 is scrolled.

FIG. 9 is a flowchart showing an example of a procedure of display control processing executed by the electronic apparatus of the embodiment.

FIG. 10 is a flowchart showing an example of a procedure of thumbnail image scroll processing executed by the electronic apparatus of the embodiment.

FIG. 11 is a flowchart showing an example of a procedure of date selection processing executed by the electronic apparatus of the embodiment.

### DETAILED DESCRIPTION

Various embodiments will be described hereinafter with reference to the accompanying drawings.

In general, according to one embodiment, an electronic apparatus includes a communication device, a display and a processor. The communication device is configured to communicate with an external storage device which stores data concerning images. The processor is configured to: display, when display of a list of the images based on the data concerning the images stored in the external storage device is requested, thumbnail images corresponding to the images on a screen of the display based on attributes associated with the images; display a first element superimposed on a first thumbnail image arranged at a first position of the displayed thumbnail images, the first element indicative of a first attribute associated with a first image corresponding to the first thumbnail image; display, when the first element is selected, elements indicative of attributes precedent to or subsequent to the first attribute of the attributes associated with the images; and display, when a second element is selected from the displayed elements, the thumbnail images, which include a second thumbnail image arranged at the first position, on the screen, the second thumbnail image corresponding to a second image with which a second attribute indicated by the second element is associated.

An electronic apparatus of an embodiment can be realized as, for example, a smartphone, tablet computer, personal digital assistant (PDA), digital camera or the like. Here, a case where the electronic apparatus is realized as a smartphone 10 is exemplified.

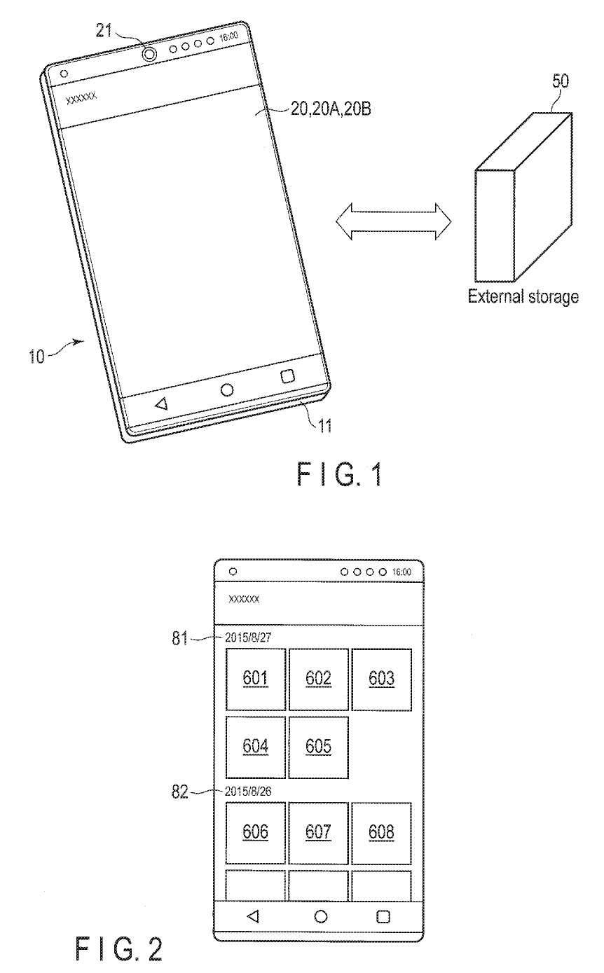

FIG. 1 is a view showing an example of an external appearance of the smartphone 10 and external storage device (hereinafter referred to also as external storage) 50 connected to the smartphone 10.

As shown in FIG. 1, the smartphone 10 includes a main body 11 and touchscreen display 20. At a predetermined position of the main body 11, for example, a central position of a front upper end of the main body 11, a camera (camera unit) 21 is arranged. It should be noted that the camera 21 may be provided in the back surface of the main body 11, or two cameras may be provided in both the front and back surfaces of the main body 11.

The touchscreen display 20 includes a liquid crystal display (LCD) 20A and touchpanel 20B. The touchpanel 20B is attached to a surface of the main body 11 to cover the screen of the LCD 20A. The touchscreen display 20 detects a contact position of an external object (stylus or finger) on the screen of the touchscreen display 20.

The smartphone 10 is connected to the external storage 50 and exchanges data with the external storage 50. The smartphone 10 and the external storage 50 are connected to each other wirelessly in conformance with a communication standard such as wireless LAN, Bluetooth (registered trademark), 3G/4G/LTE, and the like. In the following description, a case where the smartphone 10 and the external storage 50 are connected to each other by a wireless LAN will be exemplified.

The smartphone 10 can move (or copy) data stored in the smartphone 10 to the external storage 50 through the wireless connection or can move (or copy) data stored in the external storage 50 to the smartphone 10. The smartphone 10 stores, for example, an image, which is stored in the smartphone 10, in the external storage 50 through the wireless LAN. This image is, for example, an image, video or the like. Thereby, it is possible to back up, for example, an image in the smartphone 10 to the external storage 50 and move images straining the storage capacity of the smartphone 10 to the external storage 50. An image can include a thumbnail image formed by reducing the display size (size in which an original image is displayed) in which the image is displayed. This thumbnail image is generated or updated when the original image is generated or updated.

It should be noted that multiple electronic apparatuses such as the smartphones might store images in the external storage 50. In that case, the multiple electronic apparatuses can share the images with each other by utilizing the external storage 50.

Images stored in the external storage 50 can be displayed on the smartphone 10. For example, as shown in FIG. 2, a list of images (list of thumbnail images) stored in the external storage 50 is displayed on the screen. In such a list of images, images are displayed in the order based on an attribute associated with each image such as a generation date. For example, below the text 81 and 82 indicative of capturing dates, images 601 to 604 and images 606 to 608 are displayed respectively.

There is a possibility of the number of images stored in the external storage 50 reaching an enormous number. Accordingly, in the screen shown in FIG. 2, there are cases where images arranged in the order based on capturing dates have to be scrolled repeatedly to find a desired image, and such operations are very troublesome to the user.

In general, the number of images (thumbnail images) which can be displayed on a screen of a smart phone at a time is less than the number of images which can be displayed on a screen of a desktop computer or a tablet computer larger than the screen of the smartphone. For this reason, in the smartphone, there is a strong possibility of the number of times of scroll operations required to find a desired image becoming greater than the computer provided with a larger screen. Accordingly, in the electronic apparatus such as the smartphone or the like provided with the smaller screen, it becomes more troublesome to find a desired image by the scroll operation.

Accordingly, in this embodiment, an element (for example, a button) indicative of an attribute (for example, a date such as a generation date or an update date of an image) associated with the displayed image is displayed, and the displayed list of images is changed according to the attribute (date) specified in an operation using this element. The attribute of the desired image can be easily specified by using the element indicative of the attribute associated with the image, whereby the desired image is quickly displayed on the screen, and hence the desired image can be found within a short time.

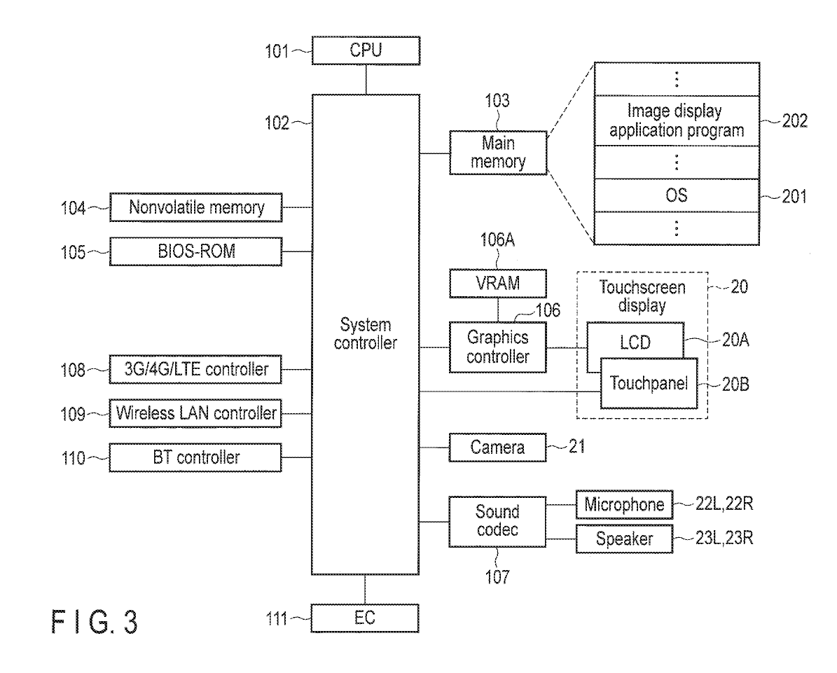

FIG. 3 shows the system configuration of the smartphone 10 of this embodiment.

As shown in FIG. 3, the smartphone 10 includes a CPU 101, a system controller 102, a main memory 103, a nonvolatile memory 104, a BIOS-ROM 105, a graphics controller 106, a video RAM (VRAM) 106A, a sound codec 107, a 3G/4G/LTE controller 108, a wireless LAN controller 109, a Bluetooth (BT) controller 110, an embedded controller (EC) 111, and the like.

The CPU 101 is a processor configured to control operations of components in the smartphone 10. This processor includes a circuit (processing circuit). The CPU 101 executes various programs loaded from the nonvolatile memory 104 into the main memory 103. These programs include an operating system (OS) 201, and various application programs. These application programs include an image display application program 202.

Some of features of the image display application program 202 will be described below.

The image display application program 202 is downloaded from a server on the Internet through, for example, the 3G/4G/LTE controller 108 or the wireless LAN controller 109, and is stored in the nonvolatile memory 104 (i.e., is installed in the smartphone 10). The image display application program 202 may also be preinstalled in the nonvolatile memory 104 at the time of shipment of the smartphone 10.

The image display application program 202 has a display function used to display an image stored in the external storage 50. By using this display function, it is possible to display images based on image files stored in the external storage 50 on the screen of the LCD 20A, and display a list of the images on the screen of the LCD 20A. In the list of the images, for example, thumbnail images formed by reducing (simplifying) the display size of the images based on the image files stored in the external storage 50 are displayed in place of the images themselves.

This display function also includes a function of displaying, when a list of the images (list of thumbnail images) is displayed, one or more elements each indicative of an attribute associated with one of the displayed images, and changing the displayed list of the images according to the attribute specified in the operation using this element (or elements). The attribute include, for example, a date such as a generation date or an update date of one of the displayed images.

The function of the image display application program 202 can be realized by a circuit such as a processor. Alternatively, this function can also be realized by a dedicated circuit.

The CPU 101 also executes a basic input/output system (BIOS) stored in the BIOS-ROM 105. The BIOS is a program for hardware control.

The system controller 102 is a device configured to connect a local bus of the CPU 101 and various components. In the system controller 102, a memory controller configured to access-control the main memory 103 is also incorporated. Further, the system controller 102 also has a function of executing communication with the graphics controller 106 through a serial bus or the like conforming to the PCI EXPRESS standard.

The system controller 102 also incorporates therein a SATA controller configured to control the nonvolatile memory 104. Further, the system controller 102 also has a function of executing communication with the graphics controller 106 and sound codec 107.

The graphics controller 106 is a display controller configured to control the LCD 20A of the touchscreen display 20. The display controller includes a circuit (display control circuit). The graphics controller 106 receives data used for display of the LCD 20A from the CPU 101, and transfers the received data to the VRAM 106A. The graphics controller 106 uses data stored in the VRAM 106A to generates a display signal to be output to the LCD 20A. The graphics controller 106 outputs the generated display signal to the LCD 20A.

The LCD 20A displays a screen image based on the display signal. The touchpanel 20B covering the LCD 20A functions as a sensor configured to detect a contact position between the screen of the LCD 20A and external object.

The sound codec 107 is a sound source device. The sound codec 107 converts audio data to be reproduced into an analog signal, and supplies the analog signal to speakers 23L and 23R. Further, the sound codec 107 converts the sound (analog signal) input from microphones 22L and 22R to a digital signal, and outputs the digital signal corresponding to the sound.

The 3G/4G/LTE controller 108 is a wireless communication device configured to execute wireless communication conforming to, for example, the 3G/4G/LTE standard. The 3G/4G/LTE controller 108 includes a transmission circuit configured to transmit a signal, and a reception circuit configured to receive a signal.

The wireless LAN controller 109 is a wireless communication device configured to execute wireless communication conforming to, for example, the IEEE 802.11 standard. The wireless LAN controller 109 includes a transmission circuit configured to transmit a signal wirelessly, and a reception circuit configured to receive a signal wirelessly.

The BT controller 110 is a wireless communication device configured to execute wireless communication conforming to the Bluetooth standard. The BT controller 110 includes a transmission circuit configured to transmit a signal, and a reception circuit configured to receive a signal.

It should be noted that the smartphone 10 may further include a LAN controller serving as a wired communication device configured to execute wired communication conforming to, for example, the IEEE 802.3 standard.

At least one of the 3G/4G/LTE controller 108, the wireless LAN controller 109, and the BT controller 110 is used to carry out wireless communication with the above-mentioned external storage 50. In the following description, a case where the wireless LAN controller 109 is used for communication with the external storage device 50 will be exemplified.

The EC 111 is a single-chip microcomputer including an embedded controller used for power management. The EC 111 powers on or off the smartphone 10 according to an operation of a power button by the user.

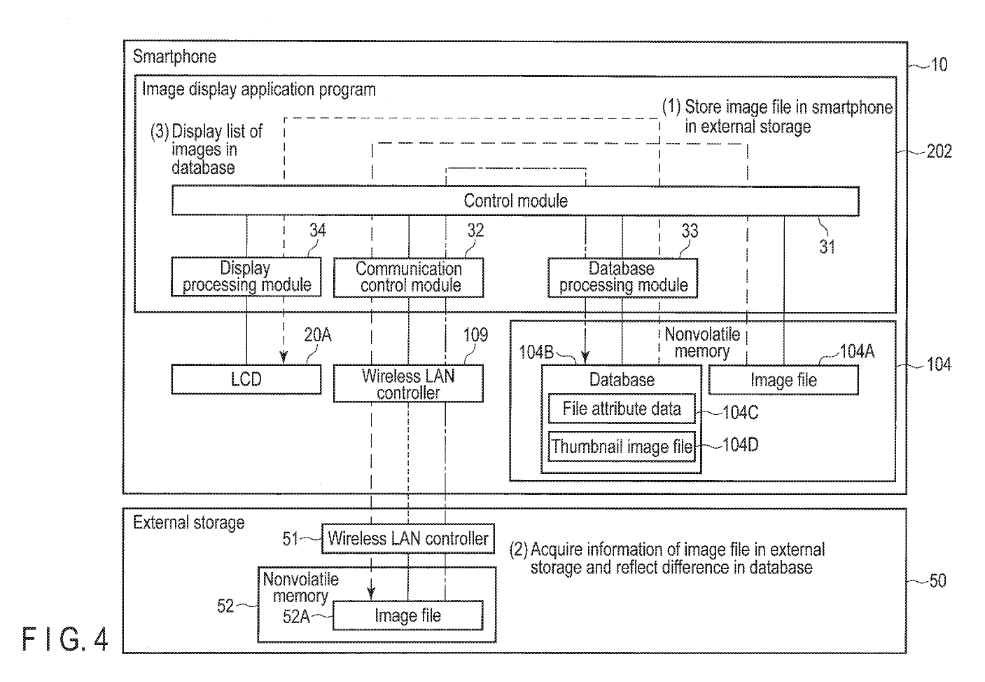

FIG. 4 shows the functional configuration of the image display application program 202.

The image display application program 202 includes, as functional modules of the program 202, a control module 31, communication control module 32, database processing module 33, and display processing module 34. The control module 31 controls operations of the modules 32, 33, and 34 in the image display application program 202.

The control module 31 receives various events from the touchpanel 20B through a touchpanel driver or the like provided in the OS 201. These events include a touch event, a movement event, and a release event. The touch event is an event indicating that the external object is brought into contact with the screen of the LCD 20A. This touch event includes coordinates indicative of a contact position between the screen and the external object. The movement event is an event indicating that the contact position has been moved while the external object contacts with the screen. This movement event includes coordinates of the contact position of the movement destination. The release event is an event indicating that the contact between the external object and the screen has been released. This release event includes coordinates indicative of a release position at which the contact has been released.

The control module 31 can detect what operation (a tap, swipe or the like) has been carried out at which position on the screen based on the various received events. The control module 31 executes processing corresponding to the detected operation.

Further, the control module 31 manages various files stored in the storage area (for example, the nonvolatile memory) 104. In the nonvolatile memory 104, a file (or files) 104A of an image (including image and video) generated by the user are stored. It should be noted that a file such as a document or text may be stored in the nonvolatile memory 104.

The control module 31 detects an operation or an event for storing the image file 104A in the nonvolatile memory 104, in the external storage 50. This operation or event includes, for example, an operation of tapping a predetermined button for the storing displayed on the screen or an event indicating that a new image file has been stored in the nonvolatile memory 104. The control module 31 reads image file 104A from the nonvolatile memory 104 according to this operation or event.

The communication control module 32 transmits the read image file 104A to the external storage 50 through the wireless LAN controller 109. The external storage 50 receives the image file 104A transmitted from the smartphone 10 through a wireless LAN controller 51, and stores the received file 104A in a nonvolatile memory 52.

Further, the control module 31 detects an operation or an event to update file attribute data 104C (an example of first data) in the nonvolatile memory 104 (database 104B). This operation or event includes, for example, an event indicating that the image display application program 202 has been started, an event indicating that the smartphone 10 has been activated, or a predetermined operation for updating the database 104B. In response to this operation or event, the control module 31 requests the communication control module 32 to acquire attribute data of an image file 52A stored in the nonvolatile memory 52 of the external storage 50.

In response to this request, the communication control module 32 acquires the attribute data of image file 52A stored in the nonvolatile memory 52 of the external storage 50. That is, the communication control module 32 accesses the external storage 50 through the wireless LAN controller 109 to thereby read the attribute data of image file 52A stored in the nonvolatile memory 52. This attribute data includes, for example, date data indicative of dates on which image files 52A have been generated or updated.

The database processing module 33 update the file attribute data 104C in the database 104B by using the read attribute data. The database processing module 33 detects attribute data of an image file not included in the file attribute data 104C, from the read attribute data items, and adds a record corresponding to the attribute data to the file attribute data 104C. Further, the database processing module 33 detects attribute data the contents of which have been changed from a record of an image file included in the file attribute data 104C, from the read attribute data, and updates the record by using the read attribute data. Furthermore, the database processing module 33 may delete a record of an image file not included in the read attribute data from the file attribute data 104C. That is, the database processing module 33 may delete a record of the file attribute data 104C corresponding to an image file that has already disappeared from the external storage 50.

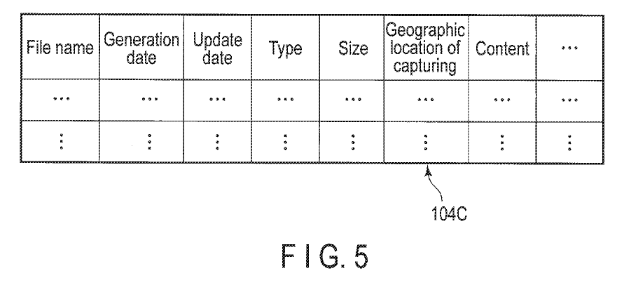

FIG. 5 shows a configuration example of the file attribute data 104C. As shown in FIG. 5, although the file attribute data 104C may be managed in a table form, the management of the file attribute data 104C is not limited to this aspect. The file attribute data 104C includes records corresponding to the image files 52A stored in the external storage 50. Each of the records includes, for example, a “file name” field, “generation date” field, “update date” field, “type” field, “size” field, “geographic location of capturing” field, “content” field, and the like.

In a record corresponding to a certain image, the “file name” field indicates a file name (or a file path) of the image. The “generation date” field indicates a date (year, month, and day) on which the image was generated (captured). The “update date” field indicates a date on which the image was updated. Each of the “generation date” field, and “update date” field may include information concerning time (hour, minute, and second). The “type” field indicates a file format (for example, JPEG, MPEG, and the like) of the image. The “size” field indicates a file size of the image. The “geographic location of capturing” field indicates a position (for example, GPS information) at which the image was captured. The “content” field indicates the contents (for example, a name of a person included in the image, name of an object included in the image, image feature, and the like) of the image.

Besides, the control module 31 detects an operation or an event for updating a thumbnail image file 104D (an example of second data) in the nonvolatile memory 104 (database 104B). This operation or event includes, for example, an event in which a thumbnail image based on a thumbnail image file not stored in the database 104B is displayed on the screen. In response to this operation or event, the control module 31 requests the communication control module 32 to acquire a thumbnail image file corresponding to image file 52A stored in the external storage 50 (nonvolatile memory 52).

In response to this request, the communication control module 32 acquires the thumbnail image file corresponding to image file 52A stored in the external storage 50 (nonvolatile memory 52). That is, the communication control module 32 accesses the external storage 50 through the wireless LAN controller 109 to thereby read the thumbnail image file (thumbnail image data) corresponding to image file 52A stored in the nonvolatile memory 52.

The database processing module 33 adds the read thumbnail image file to the database 104B.

Besides, the control module 31 detects an operation or an event for displaying a list of images based on the image files 52A stored in the external storage 50. This operation or event includes, for example, an event indicating that the image display application program 202 has been started. In response to this operation or event, the control module 31 requests the database processing module 33 and the display processing module 34 to execute processing of displaying a list of the images.

When displaying a list of the images based on the image files 52A stored in the external storage 50 is requested, the display processing module 34 displays thumbnail images corresponding to the images on the screen of the LCD 20A based on attributes associated with the images. The display processing module 34 displays a first element superimposed on a first thumbnail image arranged at a first position (for example, a left upper end) of the displayed thumbnail images. The first element indicates a first attribute associated with a first image corresponding to the first thumbnail image. When the first element is selected, the display processing module 34 displays elements indicative of attributes precedent to or subsequent to the first attribute among attributes associated with the images. Then, when a second element is selected from the displayed elements, the display processing module 34 displays the thumbnail images, which includes a second thumbnail image corresponding to a second image associated with a second attribute indicated by the second element is arranged at the first position, on the screen. One of the aforementioned attributes associated with the images is, for example, a date on which each image was generated or updated. Accordingly, when the attribute is a date, the attributes precedent to the first attribute include a date precedent to the date of the first attribute, and the attributes subsequent to the first attribute include a date subsequent to the date of the first attribute.

More specifically, in response to a request from the control module 31 to execute processing of displaying a list of the images, the database processing module 33 reads the file attribute data 104C and thumbnail image files 104D stored in the database 104B in the nonvolatile memory 104. It should be noted that the database processing module 33 may also read, from the database 104B, date data indicative dates on which the images were generated or updated, i.e., data of the “generation date” field or the “date of update” field of the file attribute data 104C, and thumbnail image files 104D.

The display processing module 34 displays thumbnail images based on the read thumbnail image files 104D on the screen of the LCD 20A based on attributes associated with the corresponding images (image files 52A) by using the read file attribute data 104C (date data). For example, the display processing module 34 displays the thumbnail images on the screen in first order based on dates on which corresponding images were generated or updated (for example, in descending order of the dates). Then, the display processing module 34 displays an element superimposed on the thumbnail image arranged at the first position (for example, the left upper end) of the displayed thumbnail images. The element indicates a date (for example, a generation date or an update date) associated with the image corresponding to the thumbnail image. The image corresponding to the thumbnail image is an original image of the thumbnail image.

As described above, the file attribute data 104C used to display a list of thumbnail images and elements indicative of dates is stored in advance in the database 104B, and is updated, for example, each time the image display application program 202 is started. Thereby the latest state of image files 52A stored in the external storage 50 is reflected in the file attribute data 104C. In addition, the thumbnail image file 104D, which has already been displayed once on the screen, is also stored in the database 104B. By using the file attribute data 104C and thumbnail image file 104D stored in the database 104B, it is possible to display a list of thumbnail images and an element indicative of a date on the screen within a shorter time than, for example, the case where data is acquired by accessing the external storage 50 after display of a list of thumbnail images is requested.

Furthermore, the control module 31 can also detect an operation on the displayed list of thumbnail images and the element indicative of a date. In response to this operation, the control module 31 causes the display processing module 34, the communication control module 32, and the database processing module 33 to execute processing for updating the display of the screen.

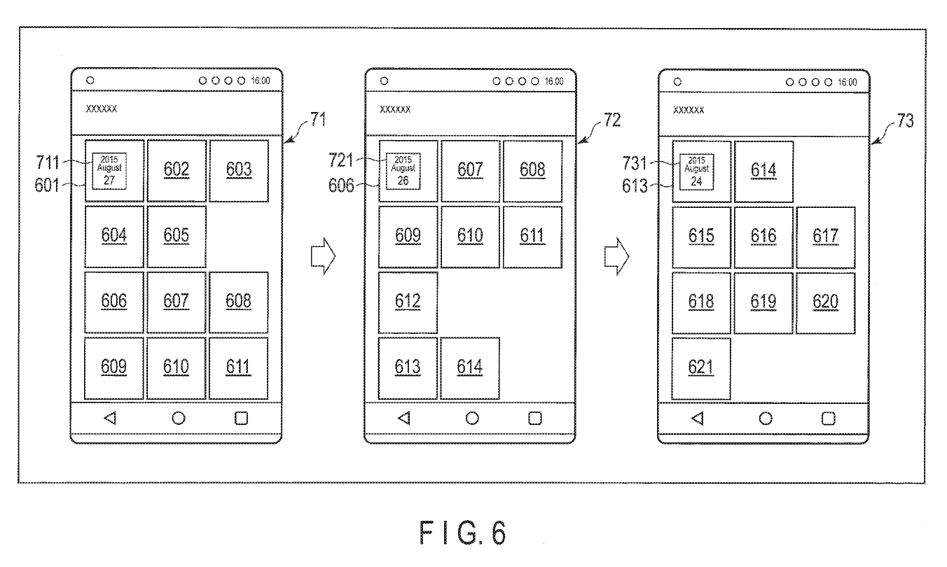

FIGS. 6 to 8 show examples of screen transitions according to operations on a list of thumbnail images and an element indicative of a date.

First, by referring to FIG. 6, an example of a case where a list of thumbnail images is scroll-operated on a screen on which the list of the thumbnail images and an element indicative of an attribute of an image are displayed will be described below. The attribute of an image is, for example, a date such as a generation date or an update date of the image. It should be noted that the generation date or the update date of the image is a date indicative of a date identical to a generation date or an update date of an image file (image data) corresponding to the image. In the following description, a case where a generation date is used as an attribute of this image is exemplified.

On each of screens 71, 72, and 73 shown in FIG. 6, part of thumbnail images 601 to 621 are displayed. For example, thumbnail images 601 to 605 are thumbnail images corresponding to images generated on Aug. 27, 2015. Thumbnail images 606 to 612 are thumbnail images corresponding to images generated on Aug. 26, 2015. Thumbnail images 613 and 614 are thumbnail images corresponding to images generated on Aug. 24, 2015. Further, thumbnail images 615 to 621 are thumbnail images corresponding to images generated on Aug. 23, 2015. It should be noted that in thumbnail images 601 to 621, thumbnail images corresponding to images generated on Aug. 25, 2015, are not included. That is, no images are generated on Aug. 25, 2015, and hence no images generated on Aug. 25, 2015, are stored in the external storage 50.

On screen 71, a list of thumbnail images 601 to 611, and an element 711 indicative of a generation date of the image corresponding to thumbnail image 601 are displayed. Thumbnail images 601 to 611 are arranged in predetermined order (here, in descending order) based on the generation date (generation date/time) according to an arrangement pattern (here, 4 rows×3 columns) of images to be determined by taking the screen size (resolution) of the LCD 20A or the like into consideration. Thumbnail images 601 to 611 are collectively arranged for each generation date, and hence, for example, thumbnail images 601 to 605 of the five images generated on Aug. 27, 2015, are arranged in sequence from the left upper end. That is, thumbnail images 601, 602, and 603 are arranged in the first row, and thumbnail images 604 and 605 are arranged in the second row.

On the right side of the last thumbnail image 605, no thumbnail image is arranged, and the thumbnail images of images generated on another date are arranged in the subsequent rows. For example, thumbnail images 606 to 611 of the six images generated on Aug. 26, 2015, which is the day before Aug. 27, 2015, are arranged in sequence from the left end of the third row. That is, thumbnail images 606, 607, and 608 are arranged in the third row, and thumbnail images 609, 610, and 611 are arranged in the fourth row. It should be noted that thumbnail images 601 to 611 may also be arranged in ascending order of the generation date (generation date/time) or in ascending order or descending order of an element indicative of another attribute.

Element 711 indicates a generation date of the image corresponding to thumbnail image 601 arranged at the first position (also here, the left upper end) of thumbnail images 601 to 611 arranged on screen 71. Accordingly, in element 711, text “2015 August 27” indicative of the generation date of the image corresponding to thumbnail image 601 is included.

When the user performs an operation of scrolling (for example, swiping) thumbnail images 601 to 611 on screen 71, the display processing module 34 displays the scrolled thumbnail images 601 to 611 according to the operation (i.e., a scroll amount, and scroll direction). The display processing module 34 sequentially deletes part of thumbnail images 601 to 611, which reaches the end part of the screen by this scroll operation, from the screen, and controls such that thumbnail images precedent to or subsequent to thumbnail images 601 to 611 are sequentially displayed in the area made vacant by the scroll operation.

Further, the display processing module 34 also updates element 711 indicative of the generation date in conjunction with the scroll operation of the thumbnail images. The display processing module 34 displays element 711 (an example of a fourth element) superimposed on a thumbnail image (an example of a fourth thumbnail image) newly arranged at the first position (for example, the left upper end) of the scrolled thumbnail images 601 to 611. Element 711 indicates an attribute (fourth attribute) associated with an image (an example of a fourth image) corresponding to the thumbnail image. The fourth attribute is, for example, a date on which the image was generated. That is, element 711 indicative of the generation date is dynamically updated to an element indicative of a generation date of the image corresponding to the thumbnail image newly arranged at the first position by the scroll operation.

For example, as shown on screen 72, thumbnail images 601 to 605 which have been made to reach the upper end of the screen by the operation of scrolling thumbnail images 601 to 611 from below to above on screen 71 are made to disappear from the screen. In addition, thumbnail images 606 to 611 are upwardly moved to thereby be arranged in the first and second rows of screen 72. Further, thumbnail images 612 to 614 of images generated earlier than the image corresponding to thumbnail image 611 are newly arranged in the third and fourth rows corresponding to an area consequently made vacant after thumbnail images 606 to 611 have been upwardly moved.

Further, an element 721, which indicates a generation date of the image corresponding to thumbnail image 606 arranged at the first position (also here, the left upper end) of thumbnail images 606 to 614 arranged on screen 72, is displayed on thumbnail image 606. In this element 721, text “2015 August 26” indicative of the generation date of the image corresponding to thumbnail image 606 is included.

Furthermore, as shown on screen 73, by the operation of scrolling thumbnail images 606 to 614 from below to above on screen 72, thumbnail images 606 to 612, which have been reached the upper end of the screen, are made to disappear from the screen and thumbnail images 613 and 614 are arranged in the first row of screen 73 by moving them upwardly. Further, thumbnail images 615 to 621 of images generated earlier than the image corresponding to thumbnail image 614 are newly arranged in the second to fourth rows corresponding to an area consequently made vacant after thumbnail images 613 and 614 have been upwardly moved.

Further, an element 731, which indicates a generation date of the image corresponding to thumbnail image 613 arranged at the first position (also here, the left upper end) of thumbnail images 613 to 621 arranged on screen 73, is displayed on thumbnail image 613. In this element 731, text “2015 August 24” indicative of the generation date of the image corresponding to thumbnail image 613 is included.

In a similar manner, in accordance with an operation of scrolling thumbnail images 601 to 621 from above to below on screens 71, 72, and 73 performed by the user, the display processing module 34 sequentially deletes part of thumbnail images which have reached the lower end of the screen, and controls such that thumbnail images of images generated later than the images corresponding to the thumbnail images which have so far been displayed are sequentially displayed in the upper area made vacant by the scroll operation.

Further, the display processing module 34 updates each element 711, 721, or 731 indicative of the generation date to an element indicative of a generation date of the image corresponding to the thumbnail image newly arranged at the first position (for example, left upper ends) by the scroll operation.

As described above, the element indicative of the generation date of the image corresponding to the thumbnail image arranged at the first position (for example, the left upper end of the screen) is updated in conjunction with the scroll of the list of the thumbnail images on the screen, whereby the user can easily grasp images (thumbnail images) of what date are displayed on the screen.

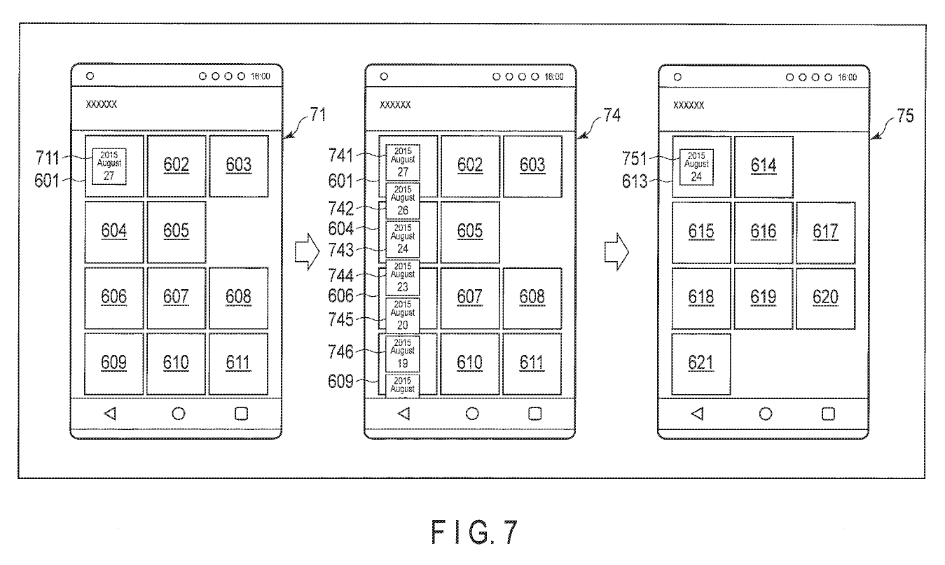

Further, as shown in FIG. 7, in accordance with an operation of selecting (for example, tapping) the element indicative of the date by the user, a list of elements indicative of dates may be also displayed.

When element 711 on screen 71 indicative of the generation date is selected, the display processing module 34 displays, as shown on screen 74, elements 741 to 746 indicative of dates precedent to a first date (Aug. 27, 2015) indicated by the selected element 711 among the dates on which the image files 52A in the external storage 50 have been generated.

On screen 74, like screen 71, a list of thumbnail images 601 to 611 is displayed. Further, a list of elements 741 to 746 in which the generation date (Aug. 27, 2015) which is indicated by element 711 is arranged at the head is displayed. These elements 741 to 746 indicate generation dates precedent to the generation date (Aug. 27, 2015) which is indicated by element 711 among the generation dates of the image files 52A stored in the external storage 50. It should be noted that when thumbnail images 601 to 611 are arranged in ascending order of generation date, a list including elements indicative of generation dates subsequent to the generation date (Aug. 27, 2015) which is indicated by element 711 among the generation dates of image files 52A stored in the external storage 50 may be displayed.

The list of elements 741 to 746 indicative of the generation dates is displayed, whereby the user can easily grasp generation dates of images earlier than the generation date indicated by element 711. Further, by performing an operation of selecting (tapping), for example, one element 746 from the list of these elements 741 to 746, the user can instruct to display an image (thumbnail image) of the generation date indicated by element 746.

When, for example, element 743 is selected from elements 741 to 746, the display processing module 34 displays, as shown on screen 75, thumbnail images based on thumbnail files 104D in the first order (for example, in descending order of generation date). The displayed thumbnail images include a thumbnail image which corresponds to the image generated on a second date indicated by the selected element 743 and is arranged at the head on the screen. On this screen 75, a list of thumbnail images 613 to 621 in which thumbnail images 613 and 614 of the images generated on Aug. 24, 2015, that is the generation date indicated by element 743 are arranged at the head is displayed. Thumbnail images 613 and 614 are arranged in the leading row (first row) of the list of thumbnail images 613 to 621. And element 751 indicative of the generation date (i.e., the generation date which is indicated by the selected element 743) of the image corresponding to thumbnail image 613 arranged at the first position (here, the left upper end) of thumbnail images 613 to 621 is displayed on thumbnail image 613.

As described above, in accordance with the operation of selecting an element 711 indicative of a generation date on screen 71, the list of elements 741 to 746 in which the above generation date is arranged at the head is displayed. Furthermore, in accordance with the operation of selecting the one element 743 from elements 741 to 746, it is possible to display the list of thumbnail images 613 to 621 in which thumbnail images 613 and 614 corresponding to the images of the generation date indicated by element 743 are arranged at the head. As described above, the user can easily select a generation date of the desired image, whereby the user can quickly display the desired image (thumbnail image) on the screen.

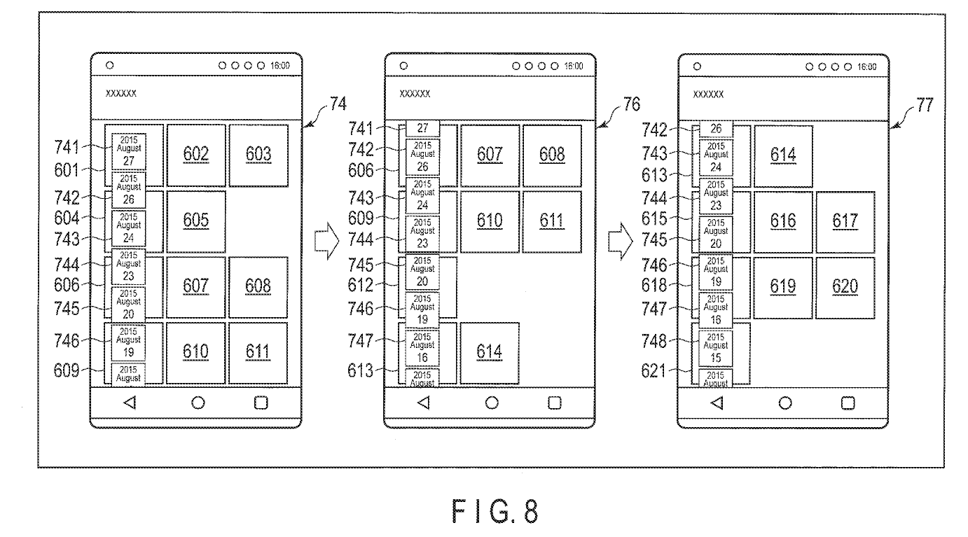

Next, FIG. 8 shows an example of a screen to be displayed in accordance with an operation of scrolling (for example, swiping) a list of elements of dates performed by the user. On a screen 74, a list of thumbnail images 601 to 611 in which thumbnail images 601 to 605 of images generated on a generation date (Aug. 27, 2015) indicated by an element 741 are arranged at the head is displayed.

When the user performs an operation of scrolling elements 741 to 746 indicative of generation dates on screen 74, the display processing module 34 displays, as shown on screen 76, the scrolled elements 741 to 747 in accordance with the operation (i.e., a scroll amount and scroll direction). The display processing module 34 sequentially deletes part of elements 741 to 746, which made to reach the end part of the screen by this scroll operation, from the screen, and controls such that element 747 precedent to or subsequent to elements 741 to 746 is sequentially displayed in the area made vacant by the scroll operation.

On screen 76, by the operation of scrolling elements 741 to 746 from below to above on screen 74, part of element 741 which has been made to reach the upper end of the screen is made to disappear from the screen, and elements 742 to 746 are upwardly moved, whereby an element 747 indicative of a generation date earlier than element 746 is newly displayed in the area made vacant by the upward movement.

Then, the display processing module 34 also scroll-displays a list of thumbnail images 601 to 611 in conjunction with the scroll operation of elements 741 to 746 indicative of the generation dates. The display processing module 34 detects element 742 (an example of a third element) in the area corresponding to the thumbnail image arranged at, for example, the first position (for example, the left upper end) of the scroll-displayed elements 741 to 747. The display processing module 34 displays thumbnail images, which includes a thumbnail image (third thumbnail image) with which an attribute (third attribute) indicated by the detected element 742 is associated is arranged at the first position (for example, the left upper end) of the thumbnail images, on the screen. This third attribute is, for example, a date on which an image was generated. As shown on screen 76, the display processing module 34 displays thumbnail images 606 to 612 in the first order (for example, in descending order) on the screen. The displayed thumbnail image 606 of the image generated on Aug. 26, 2015, that is the generation date indicated by the detected element 742 is arranged at the first position of the displayed thumbnail images 606 to 612.

Furthermore, as shown on screen 77, element 741, and part of element 742 both of which have been made to reach the upper end of the screen by the operation of scrolling elements 741 to 747 from below to above on screen 76 are made to disappear from the screen, and elements 742 to 747 are upwardly moved, whereby an element 748 indicative of a generation date earlier than element 747 is newly displayed in the area made vacant by the upward movement.

Further, an element 743 newly displayed (arranged) by the scroll operation in the area corresponding to the thumbnail image arranged at the first position (here, the left upper end) is detected, and the list of the thumbnail images arranged in screen 77 is updated based on the generation date (Aug. 24, 2015) indicated by this element. That is, a list of thumbnail images 613 to 614 in which thumbnail image 613, which corresponds the image generated on Aug. 24, 2015, that is the generation date indicated by element 743, is arranged at the head is displayed.

Likewise, in accordance with the operation of scrolling elements 741 to 748 indicative of the generation dates from above to below on screens 74, 76, and 77 performed by the user, the display processing module 34 sequentially deletes part of the elements, which have been made to reach the lower end of the screen, from the screen, and controls such that elements indicative of generation dates later than the elements, which have been displayed, are sequentially displayed in the upper area made vacant by the scroll operation. Further, the display processing module 34 detects an element newly displayed by the scroll operation in the area corresponding to the thumbnail image of the first position, and updates the list of the thumbnail images which have been displayed to a list of thumbnail images in which a thumbnail image of the image generated on the generation date indicated by the above element is arranged at the head.

As described above, by the operation of scrolling a displayed list of elements indicative of generation dates, the user can quickly display an element of a generation date which the user desires to select.

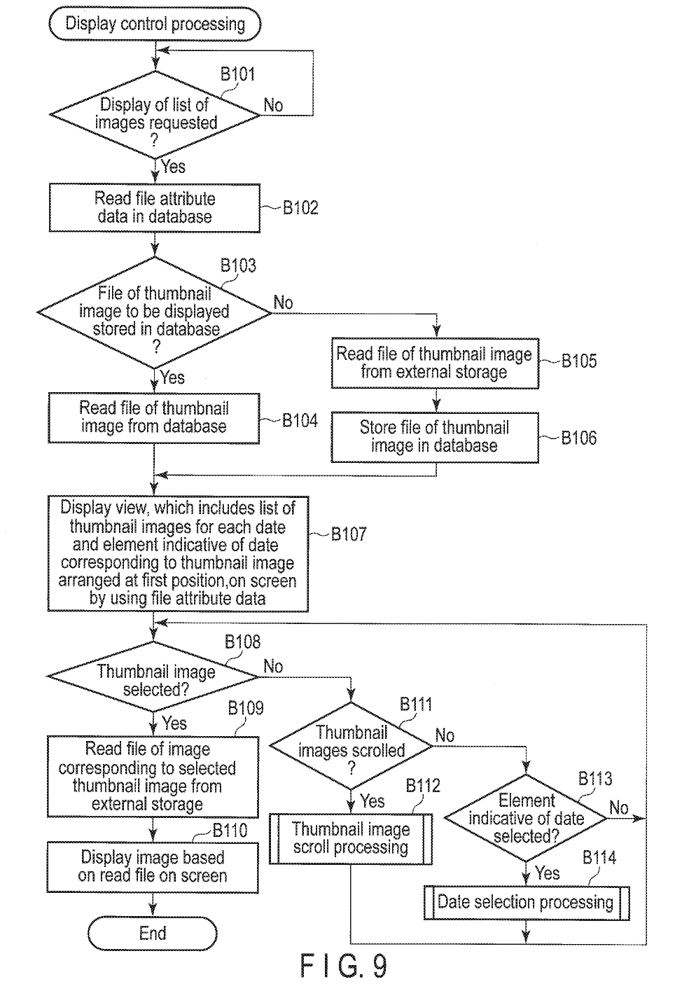

Next, an example of the procedure of display control processing executed by the smartphone 10 will be described below with reference to a flowchart of FIG. 9.

The CPU 101 determines whether display of a list of images stored in the external storage 50 has been requested (B101). For example, when the image display application program 202 has been started, the CPU 101 determines that display of a list of images has been requested. When display of a list of images is not requested (No in B101), the flow returns to B101, and it is determined again whether display of a list of images is requested.

When display of a list of images is requested (Yes in B101), the CPU 101 reads the file attribute data 104C in the database 104B (B102). The CPU 101 may read necessary records of the file attribute data 104C based on the number of thumbnail images which can be displayed on the screen of the LCD 20A. For example, as shown in the screen examples of FIGS. 6 to 8, when 12 (=4 rows×3 columns) thumbnail images can be displayed on the screen, the CPU 101 may read records of the file attribute data 104C corresponding to the thumbnail images actually displayed on the screen by taking the fact that there is an area in which no thumbnail image is arranged because thumbnail images are displayed in units of groups based on generation date or update date into consideration.

Further, the CPU 101 determines whether a file of a thumbnail image to be displayed is stored in the database 104B (B103). The file of a thumbnail image to be displayed is part of files of thumbnail images which correspond to the read records of the file attribute data 104C respectively. When the file of the thumbnail images to be displayed is stored in the database 104B (Yes in B103), the CPU 101 reads a file 104D of the thumbnail image to be displayed from the database 104B (B104).

When no file of the thumbnail image to be displayed is stored in the database 104B (No in B103), the CPU 101 reads a file (data) of the thumbnail image from the external storage 50 (B105), and stores the read file of the thumbnail image in the database 104B (B106).

Next, the CPU 101 displays a view, which includes a list of thumbnail images arranged for each date, and an element indicative of a date associated with an image corresponding to a thumbnail image arranged at the first position (for example, the left upper end) in the list, on the screen of the LCD 20A by using the read file attribute data 104C (B107). The date associated with the image is, for example, a generation date or an update date of the image. The thumbnail images are arranged, for example, in descending order of generation date or update date of the corresponding images. Further, the element indicative of the date is displayed on the thumbnail image of the first position in an overlapping manner.

The CPU 101 determines whether one thumbnail image has been selected (for example, a tap) from the displayed list of the thumbnail images (B108). When a thumbnail image has been selected (Yes in B108), the CPU 101 reads an image file 52A of the image corresponding to the selected thumbnail image from the external storage 50 (B109), and displays an image based on the read image file 52A on the screen (B110). This image is displayed on the screen in a size larger than a size of the thumbnail image, and hence the user can view the images of the larger size.

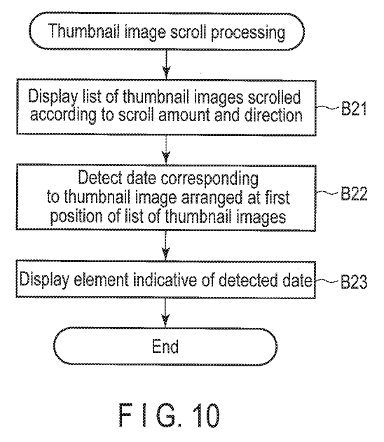

When no thumbnail image is selected (No in B108), the CPU 101 determines whether a list of the displayed thumbnail images has been scrolled (B111). That is, the CPU 101 determines whether an operation of scrolling (for example, swiping) the list of the thumbnail images has been detected. When the list of the thumbnail images has been scrolled (Yes in B111), the CPU 101 executes thumbnail image scroll processing (B112). In this thumbnail image scroll processing, the thumbnail images are scroll-displayed, and display of an element indicative of a date is updated according to the scroll-display. A procedure of the thumbnail image scroll processing will be described later with reference to the flowchart of FIG. 10.

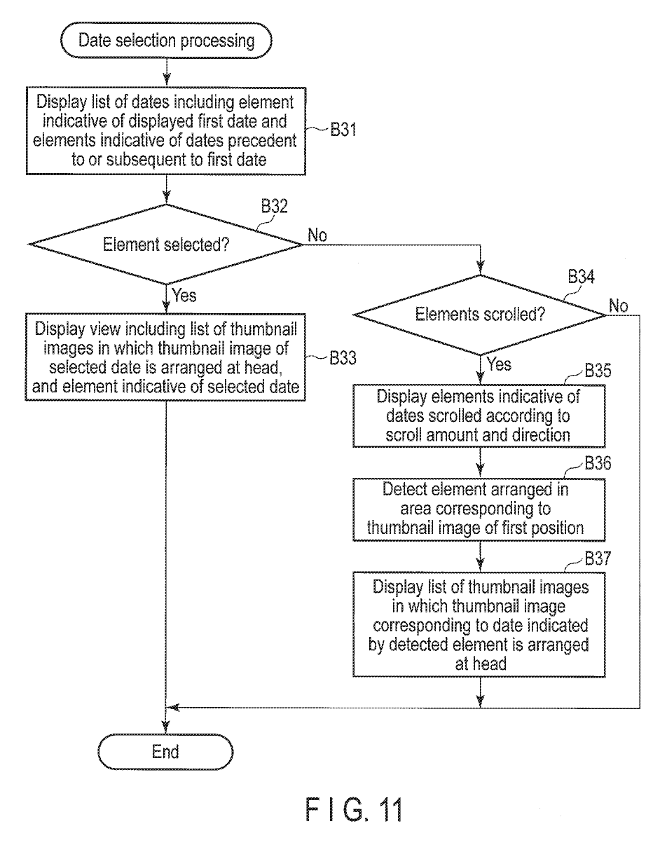

When the list of the thumbnail images has not been scrolled (No in B111), the CPU 101 determines whether an element indicative of a date has been selected (for example, tapped) (B113). When an element indicative of a date has been selected (Yes in B113), the CPU 101 executes date selection processing (B114). In this date selection processing, display of thumbnail images and an element indicative of a date (or elements indicative of dates) is updated in accordance with an operation for the element indicative of the date. A procedure of the date selection processing will be described later with reference to the flowchart of FIG. 11.

After the thumbnail image scroll processing of B112, after the date selection processing of B114, or after No in B113, the flow returns to B108, and processing corresponding to the procedure for the displayed thumbnail images and element (or elements) indicative of a date (or dates) is continued.

Next, an example of the procedure of the thumbnail image scroll processing will be described below with reference to the flowchart of FIG. 10. This processing is executed in accordance with the fact that an operation of scrolling a list of thumbnail images displayed on the screen has been detected.

The CPU 101 scrolls and displays the list of the thumbnail images being displayed according to the scroll amount and scroll direction based on the detected scroll operation (B21). It should be noted that when it is necessary to display thumbnail images precedent to or subsequent to the thumbnail images in the displayed list by the scroll operation, the CPU 101 reads necessary file attribute data 104C and thumbnail images in the manner identical to the procedure from B102 to B106 of FIG. 9. That is, the CPU 101 reads records of necessary file attribute data 104C from the database 104B, and reads necessary thumbnail image files 104D from the database 104B. Further, the CPU 101 uses the read records of the file attribute data 104C and thumbnail image files 104D to thereby scroll-display a list of the thumbnail images.

Subsequently, the CPU 101 detects a first date associated with the image corresponding to the thumbnail image arranged at the first position (for example, the left upper end) of the list of the displayed thumbnail images (B22). The CPU 101 reads information on the date (for example, a generation date or an update date) from, for example, the record of the file attribute data 104C corresponding to the thumbnail image arranged at the first position, thereby detecting the first date associated with the image corresponding to the thumbnail image.

Then, the CPU 101 displays the first element indicative of the detected first date superimposed on the thumbnail image arranged at the first position (B23).

By the procedure described above, when an operation of scrolling the list of the thumbnail images is input, it is possible to update display of the element indicative of the date in conjunction with the scroll-display of the thumbnail images.

The flowchart of FIG. 11 shows an example of the procedure of the date selection processing. This date selection processing is executed in accordance with the fact that a first element indicative of a first date displayed on the screen has been selected.

The CPU 101 displays a list of dates including the displayed first element indicative of the first date, and elements indicative of dates precedent to or subsequent to the first date (B31).

The CPU 101 reads, as dates precedent to the first date, dates (generation dates or update dates) earlier than the first date included in the records of the file attribute data 104C in order of proximity to the first date. Then, the CPU 101 displays a list of dates in which a first element indicative of the first date, and elements indicative of the read dates precedent to the first date are arranged in a line in the vertical direction in, for example, descending order of the dates on a list of thumbnail images.

Further, the CPU 101 reads, as dates subsequent to the first date, dates (generation dates or dates of update) later than the first date included in the records of the file attribute data 104C in order of proximity to the first date. Then, the CPU 101 displays a list of dates in which the first element indicative of the first date, and elements indicative of the read dates subsequent to the first date are arranged in a line in the vertical direction in, for example, ascending order of the dates on a list of thumbnail images.

Subsequently, the CPU 101 determines whether a second element indicative of a second date has been selected from the displayed list of dates (B32). When the second element indicative of the second date has been selected (Yes in B32), the CPU 101 displays a view, which includes a list of thumbnail images in which a thumbnail of the image whose generation date or update date is the second date is arranged at the head, and the second element indicative of the second date, on the screen (B33), and then terminates the processing.

When the second element indicative of the second date has not been selected (No in B32), the CPU 101 determines whether the list of dates has been scrolled (B34). That is, the CPU 101 determines whether an operation of scrolling (for example, swiping) the list of dates has been detected. When the list of dates has been scrolled (Yes in B34), the CPU 101 scrolls and displays the list of dates being displayed according to the scroll amount and scroll direction based on the detected scroll operation (B35). It should be noted that when it is necessary to display elements precedent to or subsequent to the elements in the list being displayed by the scroll operation, the CPU 101 reads records of necessary file attribute data 104C from the database 104B. Then, the CPU 101 scroll-displays the list of dates by using the read record of the file attribute data 104C.

Subsequently, the CPU 101 detects an element arranged in the area corresponding to a thumbnail image of the first position (for example, the left upper end) of the list of thumbnail images (B36). Then, the CPU 101 displays, on the screen, a list of thumbnail images in which a thumbnail image corresponding to an image whose generation date or update date is the date indicated by the detected element is arranged at the head (B37). The list of dates displayed in B35 is displayed on the list of thumbnail images in an overlapping manner. It should be noted that when it is necessary to display a thumbnail image precedent to or subsequent to the thumbnail images being displayed by the scroll operation of the list of dates, the CPU 101 reads a necessary thumbnail image file 104D from the database 104B. Then, the CPU 101 scroll-display the list of thumbnail images by using the read thumbnail image file 104D and records of the file attribute data 104C which has been read in order to display the list of dates.

By the procedure described above, it is possible to update the thumbnail images and element indicative of a date (or elements indicative of dates) being displayed according to the operation for the element (or elements).

It should be noted that when the list of dates is displayed, the user can also input an operation of scrolling the list of thumbnail images. In that case, the CPU 101 executes a procedure obtained by replacing the list of dates and the list of thumbnail images with each other in the procedure from B34 to B37 to thereby scroll-display the list of thumbnail images according to the scroll amount and scroll direction based on the scroll operation, and scroll-display the list of dates in conjunction with the above scroll-display of the list of thumbnail images.

As described above, according to the electronic apparatus and method of this embodiment, it is possible to easily find a desired image from a list of images. When display of a list of images based on data concerning images stored in the external storage device 50 is requested, the CPU 101 displays thumbnail images corresponding to the images on a screen of the LCD 20A based on attributes associated with the images. The CPU 101 displays a first element superimposed on a first thumbnail image arranged at a first position of the displayed thumbnail images, the first element indicative of a first attribute associated with a first image corresponding to the first thumbnail image. When the first element is selected, the CPU 101 displays elements indicative of attributes precedent to or subsequent to the first attribute of the attributes associated with the images. When a second element is selected from the displayed elements, the CPU 101 displays the thumbnail images, which includes a second thumbnail image arranged at the first position, on the screen, the second thumbnail image corresponding to a second image with which a second attribute indicated by the second element is associated.

Thereby, in accordance with an operation of selecting one of elements indicative of attributes associated with images, a list of images corresponding to the attribute of the selected element is displayed, and hence the user can easily find a desired image.

It should be noted that in the example described above, although a case where a list of thumbnail images corresponding to images such as still images and videos is displayed on the screen has been described, this embodiment is also applicable to a file (for example, a document file, text file or the like) other than the image file. For example, in accordance with an operation of selecting one of elements indicative of dates on which a document was generated or updated, a list of documents (for example, a list of thumbnail images or a list of icons) corresponding to the date of the selected element is displayed, and hence the user can easily find a desired document.

Further, the element, which is displayed on the thumbnail image and is indicative of an attribute, is not limited to that indicative of a date (generation date or update date), and may be an element indicative of one of other attributes of the image (file). The attributes includes, for example, a type, size, content, generation location of a file. Accordingly, it is also possible to change a displayed list of thumbnail images based on an element other than a date.

It should be noted that the connection between the smartphone 10 of this embodiment and the external storage 50 is not limited to the wireless LAN, and the smartphone 10 and the external storage 50 can be connected to each other based on various transmission (communication) standards such as Bluetooth, various communication networks, wired LAN, USB, and the like. The smartphone 10 and the external storage 50 can exchange various data such as an image file and attribute data of a file with each other through the connection conforming to the transmission standard.

Further, each of the various functions described in this embodiment may also be realized by a circuit (processing circuit). Examples of the processing circuit include a programmed processor such as a central processing unit (CPU). This processor executes each of described functions by executing a computer program (instructions) stored in a memory. This processor may be a microprocessor including electrical circuits. Examples of the processing circuit also include a digital signal processor (DSP), application specific integrated circuits (ASIC), microcontroller, controller, FPGA, and other electrical circuit components. Each of components other than the CPU described in this embodiment may also be realized by a processing circuit.

Further, the various processing operations of this embodiment can be realized by computer programs, and hence an advantage identical to this embodiment can easily be realized by only installing the computer program onto a computer through a storage medium that can be read by a computer in which this computer program is stored, the Internet, a communication network, broadcasting network, and the like, and executing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a communication device configured to communicate with an external storage device which stores data concerning images;
a display; and
a processor configured to:
display, when display of a list of the images based on the data concerning the images stored in the external storage device is requested, thumbnail images corresponding to the images on a screen of the display based on attributes associated with the images;
display a first element superimposed on a first thumbnail image arranged at a first position of the displayed thumbnail images, the first element indicative of a first attribute associated with a first image corresponding to the first thumbnail image;
display, when the first element is selected, elements indicative of attributes precedent to or subsequent to the first attribute of the attributes associated with the images; and
display, when a second element is selected from the displayed elements, the thumbnail images, which comprise a second thumbnail image arranged at the first position, on the screen, the second thumbnail image corresponding to a second image with which a second attribute indicated by the second element is associated.

2. The apparatus of claim 1, further comprising a memory that stores first data concerning the attributes associated with the images, and second data concerning the thumbnail images corresponding to the images, wherein
when display of the list of the images stored in the external storage device is requested, the processor is configured to:
read the first data and the second data from the memory; and
display the thumbnail images based on the read second data on the screen, based on the attributes associated with the images by using the read first data.

3. The apparatus of claim 1, wherein the processor is further configured to:
display, when an operation of scrolling the displayed elements is detected, the elements which are scrolled in accordance with the operation;
detect a third element of the scrolled elements, the third element in an area corresponding to a thumbnail image arranged at the first position; and
display the thumbnail images, which comprise a third thumbnail image arranged at the first position, on the screen, the third thumbnail image corresponding to a third image with which a third attribute indicated by the third element is associated.

4. The apparatus of claim 1, wherein the processor is further configured to:
display, when an operation of scrolling the displayed thumbnail images is detected, the thumbnail images which are scrolled in accordance with the operation; and
display a fourth element superimposed on a fourth thumbnail image arranged at the first position of the scrolled thumbnail images, the fourth element indicative of a fourth attribute associated with a fourth image corresponding to the fourth thumbnail image.

5. The apparatus of claim 1, further comprising a memory that stores data concerning images, wherein
the processor is further configured to transmit the data concerning images stored in the memory to the external storage device through the communication device.

6. The apparatus of claim 1, wherein
the attributes comprise dates on which the images have been generated or updated, and
the processor is configured to display the thumbnail images on the screen in descending order or ascending order of dates on which the images corresponding to the thumbnail images were generated or updated.

7. A display control method comprising:
communicating with an external storage device which stores data concerning images through a communication device;
displaying, when display of a list of the images based on the data concerning the images stored in the external storage device is requested, thumbnail images corresponding to the images on a screen of a display based on attributes associated with the images;
displaying a first element superimposed on a first thumbnail image arranged at a first position of the displayed thumbnail images, the first element indicative of a first attribute associated with a first image corresponding to the first thumbnail image;
displaying, when the first element is selected, elements indicative of attributes precedent to or subsequent to the first attribute of the attributes associated with the images; and
displaying, when a second element is selected from the displayed elements, the thumbnail images, which comprise a second thumbnail image arranged at the first position, on the screen, the second thumbnail image corresponding to a second image with which a second attribute indicated by the second element is associated.

8. The method of claim 7, further comprising:
storing first data and second data in a memory, the first data concerning the attributes associated with the images, the second data concerning the thumbnail images corresponding to the images;
reading the first data and the second data from the memory when display of the list of the images stored in the external storage device is requested; and
displaying the thumbnail images based on the read second data on the screen, based on the attributes associated with the images by using the read first data.

9. The method of claim 7, further comprising:
displaying, when an operation of scrolling the displayed elements is detected, the elements which are scrolled in accordance with the operation;
detecting a third element of the scrolled elements, the third element in an area corresponding to a thumbnail image arranged at the first position; and
displaying the thumbnail images, which comprise a third thumbnail image arranged at the first position, on the screen, the third thumbnail image corresponding to a third image with which a third attribute indicated by the third element is associated.

10. The method of claim 7, further comprising:
displaying, when an operation of scrolling the displayed thumbnail images is detected, the thumbnail images which are scrolled in accordance with the operation; and
displaying a fourth element superimposed on a fourth thumbnail image arranged at the first position of the scrolled thumbnail images, the fourth element indicative of a fourth attribute associated with a fourth image corresponding to the fourth thumbnail image.

11. The method of claim 7, further comprising:
storing data concerning images in a memory; and
transmitting the data concerning images stored in the memory to the external storage device through the communication device.

12. The method of claim 7, wherein
the attributes comprise dates on which the images have been generated or updated, and
the thumbnail images are displayed on the screen in descending order or ascending order of dates on which the images corresponding to the thumbnail images were generated or updated.

13. An electronic apparatus comprising:
a communication device configured to communicate with an external apparatus;
a memory that stores data communicated through the communication device;
a display configured to display an image based on the data stored in the memory; and
a processor configured to
transmit data concerning images to an external storage device through the communication device;
receive first data and second data from the external storage device through the communication device and store the received first data and the received second data in the memory, the first data concerning attributes associated with the images, the second data concerning thumbnail images corresponding to the images; and
when display of a list of the images based on the data concerning the images which has been transmitted to the external storage device is requested, read the first data and the second data from the memory and display thumbnail images based on the read second data on a screen of the display based on attributes associated with the images by using the read first data.

14. The apparatus of claim 13, wherein
the processor is configured to:
display a first element superimposed on a first thumbnail image arranged at a first position of the displayed thumbnail images, the first element indicative of a first attribute associated with a first image corresponding to the first thumbnail image;
display, when the first element is selected, elements indicative of attributes precedent to or subsequent to the first attribute of the attributes associated with the images; and
display, when a second element is selected from the displayed elements, the thumbnail images, which comprise a second thumbnail image arranged at the first position, on the screen, the second thumbnail image corresponding to a second image with which a second attribute indicated by the second element is associated.

15. The apparatus of claim 14, wherein the processor is further configured to:
display, when an operation of scrolling the displayed elements is detected, the elements which are scrolled in accordance with the operation;
detect a third element of the scrolled elements, the third element in an area corresponding to a thumbnail image arranged at the first position; and
display the thumbnail images, which comprise a third thumbnail image arranged at the first position, on the screen, the third thumbnail image corresponding to a third image with which a third attribute indicated by the third element is associated.

16. The apparatus of claim 14, wherein the processor is further configured to:
display, when an operation of scrolling the displayed thumbnail images is detected, the thumbnail images which are scrolled in accordance with the operation; and
display a fourth element superimposed on a fourth thumbnail image arranged at the first position of the scrolled thumbnail images, the fourth element indicative of a fourth attribute associated with a fourth image corresponding to the fourth thumbnail image.

17. The apparatus of claim 13, wherein
the processor is further configured to:
store data concerning images in a memory; and
transmit the data concerning images stored in the memory to the external storage device through the communication device.

18. The apparatus of claim 13, wherein
the attributes comprise dates on which the images have been generated or updated, and
the processor is configured to display the thumbnail images on the screen in descending order or ascending order of dates on which the images corresponding to the thumbnail images were generated or updated.
